(19) United States
(12) Patent Application Publication
(10) Pub. No.: US 2016/0061487 A1
(43) Pub. Date: Mar. 3, 2016

(54) APPARATUS AND METHOD FOR CLEANING FLUE GAS

(71) Applicant: Salvatore Deiana, Vancouver (CA)

(72) Inventor: Salvatore Deiana, Vancouver (CA)

(21) Appl. No.: 14/834,928

(22) Filed: Aug. 25, 2015

Related U.S. Application Data
(60) Provisional application No. 62/042,988, filed on Aug. 28, 2014.

(51) Int. Cl. F24H 1/00; F22B 29/06; B01D 53/79

(52) U.S. Cl. CPC F24H 1/0009; B01D 53/79; F22B 29/06; B01D 2251/604; B01D 2258/0283

(57) ABSTRACT

A multi-stage exhaust apparatus to reduce the emission of pollutants from a fossil fuel furnace and to achieve greater efficiency in the energy consumption by such furnace. The multi-stage exhaust may include a vacuum chamber boiler, a submerged pump vacuum chamber, a bath scrubber, and a clean air tower. The system may further include a secondary submerged vacuum chamber and a secondary bath scrubber.

### CROSS-REFERENCE TO RELATED APPLICATION

This application claims the benefit of priority of U.S. provisional application No. 62/042,988, filed Aug. 28, 2014, the contents of which are herein incorporated by reference.

### BACKGROUND OF THE INVENTION

The present invention relates to fossil fuel combustion and, more particularly, to controlling pollutants and greenhouse gassed created by fossil fuel combustion. Fossil fuel combustion is a major contributor to greenhouse gas emissions and a significant contributing factor to global warming, or climate change. Banning the use of fossil fuel resources is not a viable solution to control the emission of greenhouses, because many developing and third world countries have no alternative source of energy. At the same time, pollution has no respect for international boundaries and touches all of us sharing the planet.

The present invention provides an apparatus and method for cleaning flue gasses of industrial or domestic coal and gas furnaces. Burning fossil fuels such as coal, oil and gas results in serious air pollution. The manner in which conventional smoke cleaners, called scrubbers, operate is well known. Systems known as wet scrubbers shower lime water on the rising flue gasses to precipitate or physically remove particulates from the exhaust gasses. Venturi type scrubbers mix lime water and smoke in a confined space. Dry scrubbers utilize chemicals and electrostatic precipitators to intercept and remove pollutants by using opposing magnetic fields. Regardless of the scrubber type, subsequent to their treatment, all such treated exhausts are released into the atmosphere.

Present technologies are not perfect and can be improved by diminishing the imperfections that are presented in their application. The improvement of the present invention can be applied to wet scrubbers showering flue gases with lime water or chemical, to Venturi scrubbers mixing flue gases and liquid scrubbers in a restrictive passage, to resonator scrubbers in which the flue gas is cleaned by using jets of vapor, water or chemicals that are intercepted by sonic shock waves, to electrostatic precipitators where opposing polarities precipitate polluting particles.

For example precooling the exhausts is imperative because hot flue gas rise so rapidly that the duration of time that the exhausts contact and engage with the respective treating solution, its contact time, is very short, with insufficient time to absorb all the contaminants present in the exhausts. This is particularly the case with wet scrubbers, but this condition is also present with Venturi scrubbers that also suffer from short contact time.

Another significant problem with Venturi scrubbers is presented by the very confined area where the mixing of exhaust gasses and the treating solution. This limits the mixture of exhaust gasses to treating solution to a ratio of 1 to 1, which allows some contaminants to escape untreated.

According to aspects of the present invention essentially resides in providing a different and more efficient method and plant to clean flue gas caused by combustion of fossil fuels and to avoid shortcomings and inefficiencies encountered in prior art.

Leaving coal underground and unutilized presents a wasted asset. As from the story by Jesus, who praised the two servant who used the talents received and profited and condemned the servant who dug a hole in the ground and wasted the talent received. Progress is driven by faith not by fear. Coal has a reason to be on earth that is for it to be used wisely for the benefit of all. In fact electricity consumption generated by coal and standard of living go hand in hand, if one increases so does the other.

Two groups of contenders occupy the media debate on pollution. However, the proverbial elephant in the living room that nobody seems to see, presents the greatest cause of pollution: it is that only a small part of the heat created by the combustion of fossil fuels is actually used, the rest is wasted causing a greater pollution than any other source.

As can be seen, there is a need for improving the efficiency of fossil fuel combustion so that we would only need half of the plants in use and still generate the same amount of electricity and yet output only half of the pollutants.

### SUMMARY OF THE INVENTION

In one aspect of the present invention a vacuum chamber boiler is provided which includes an elongate body having a sidewall defining a cavity therein. The cavity has a sealing plate extending across the cavity and sealingly engaging with an interior surface of the sidewall to define a boiler chamber in a lower portion of the cavity and a vacuum chamber in an upper portion of the cavity. A smokestack is substantially contained within the boiler chamber and extends from a first opening at a bottom of the boiler chamber to a second opening in the sealing plate. The smokestack is adapted to communicate exhausts received from a furnace through the first opening and the second opening, where the second opening is in communication with the vacuum chamber. The boiler is adapted to receive a source of liquid for producing steam, and the vacuum chamber is adapted to receive a vacuum source applied to an outlet of thed vacuum chamber.

In preferred embodiments of the invention the smokestack is articulated within the boiler chamber. In other aspects of the invention the smokestack is articulated along a width, a length and a height of the boiler chamber. In certain preferred aspects of the invention, the length of the smoke stack within the boiler chamber is selected such as to approach equilibrium of the exhausts temperature at the sealing plate opening with the temperature of the source of liquid producing for producing steam.

In other aspects of the invention, the vacuum source comprises a vacuum pump, connected to the vacuum chamber outlet via a conduit, wherein the vacuum pump is submerged in a circulating source of cooling fluid contained within a vacuum station external to the vacuum chamber boiler. In preferred embodiments of the invention, the vacuum source comprises a plurality of vacuum pumps submerged in the vacuum station and each vacuum pump is connected to the vacuum chamber via a separate conduit.

In yet another aspect of the invention, a bath scrubber is disclosed and claimed which includes a main chamber defined by an outer wall of the bath scrubber. The main chamber has a lower portion adapted to contain a volume of a of chemical water bath to a fill line in the main chamber and an upper portion defined above the fill line. An inlet defined in said lower portion is adapted to receive exhausts from fossil fuel combustion contained in a furnace. The bath scrubber further includes a perforated plate extending across the lateral and longitudinal aspects of the main chamber beneath the fill line and has an outlet defined in the upper portion which adapted to evacuate exhausts from the bath scrubber. In other aspects of the invention the bath scrubber further comprises a plurality spray nozzles projecting into the upper portion of the main chamber. A pump may also provide a pressurized source of chemical water to the spray nozzles.

In other aspects, the bath scrubber is provisioned with a plurality of ultrasonic emitters positioned proximal the perforated plate and the emitters are arrayed to foment the exhausts within the chemical water bath.

In yet another aspect, the bath scrubber includes a vacuum source connected to the outlet. The vacuum source includes: a vacuum pump, connected to the outlet via a conduit and the vacuum pump is submerged in a circulating source of cooling fluid contained within a vacuum station external to the bath scrubber. In preferred aspects, the vacuum source includes a plurality of said vacuum pumps submerged in the vacuum station and each vacuum pump connected to the vacuum chamber via a separate conduit.

The invention also includes an apparatus for cleaning flue gas, comprising: a vacuum chamber boiler; a bath scrubber: and at least one vacuum station external to said vacuum chamber boiler and the bath scrubber.

These and other features, aspects and advantages of the present invention will become better understood with reference to the following drawings, description and claims.

### BRIEF DESCRIPTION OF THE DRAWINGS

FIG. 1 is a schematic diagram of a tall pipe fired boiler.

FIG. 2 is a schematic diagram of a short pipe fired boiler.

FIG. 3A is a schematic diagram of an embodiment of a straight stack vacuum chamber capped boiler.

FIG. 3B is a schematic diagram of an embodiment of an articulated stack vacuum chamber capped boiler.

FIG. 4 a schematic diagram of an embodiment of a bath scrubber according to an aspect of the present invention.

FIG. 5 is a side elevation schematic diagram of a flue gas cleaning system according to aspects of the present invention.

FIG. 6 is a side elevation diagram of a flue gas cleaning system according to the present invention.

FIG. 7 is an overhead plan view of a flue gas cleaning system according to the present invention.

FIG. 8 is a perspective view of a flue gas cleaning system according to the present invention.

FIG. 9 is an overhead plan view of a vitrified block field for disposal of flue gas wastes.

FIG. 10 is a side elevation view of a vitrified block field for disposal of flue gas wastes.

FIG. 11 is a perspective view of a vitrified block field for disposal of flue gas wastes.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system and method for cooling exhaust gasses to remedy inefficient combustion by providing a multi-stage system boiler capped by a vacuum chamber. The vacuum chamber makes possible an efficient energy utilization of fossil fuel combustion in a boiler.

An understanding of the present invention may be obtained by considering the following. In the first instance, imagine two fires on a field, one is fueled by dry hay, the other by wet hay. The first fire is very hot and because of the extreme temperature difference between the combustion and the air surrounding the combustion gasses ascend very rapidly. The second fire is not as hot as the first because it is smoky and so the combustion gasses ascend slowly. The temperature differential between the combustion and the surrounding atmosphere affect the speed of ascension.

Now, consider an example of a furnace. If the fire of a furnace is inducted into a very tall smoke stack, the ascension speeds of the combustion products will vary throughout the length of the smokestack. The exhausts at the base of the smokestack and close to the furnace are hot and ascending fast, whereas, the exhaust at the top of the smokestack are cooler because they have lost heat to the stack and therefore are ascending at a slower rate. If nothing is done to remedy the condition, the cooler smoke at the top of the stack may obstruct the smokestack, forcing smoke to re-enter the furnace and choke the within the furnace. Conventional practices to avoid this condition entail the utilization of several heaters, which are positioned along the smokestack to re-heat the cooler exhausts and permit them to continue their ascent and exit from the top of the stack and thereby avoid the above mentioned complications.

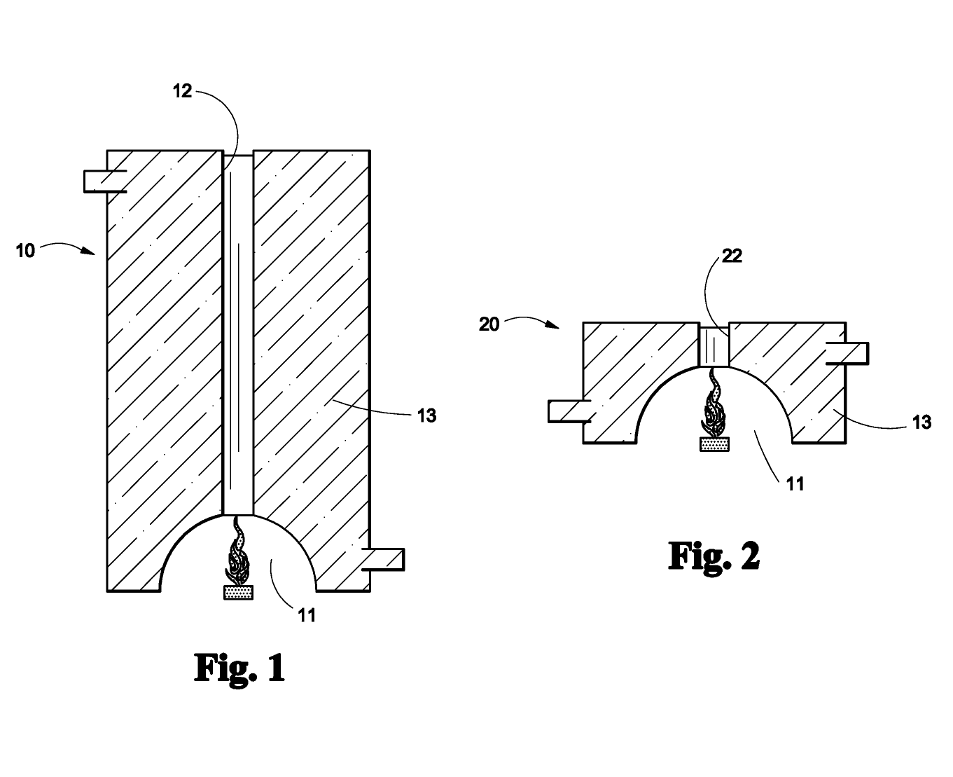

The same conditions described in the foregoing tall smokestack may also found in a tall pipe fired boiler 10, such as shown in reference to FIG. 1. In the pipe fired boiler 10, the top exhaust gasses are cooler, whereas the bottom exhaust gasses near the furnace 11 are hot. In the case of the tall pipe fired boiler 10, however, it is not possible to access the portion of the smokestack 12 inside the water boiler 13 and re-heat the cooled exhaust gasses in order to keep them moving. In this circumstance, a thermal solution, such as described above is not practical.

The conventional market solution to these deficiencies is to provide a short pipe fired boiler 20, such as that depicted in reference to FIG. 2. In the short pipe fired boiler 20, the furnace 11 is in close proximity to the water boiler 13 and the smokestack 22 is of a short height. Due to the short smokestack 22, however, the exhaust gasses exiting the stack 22 are still very hot. Consequently, the energy released by the combustion is not fully utilized. This creates unnecessary pollution and a waste of fuel energy. Other boilers have similar limitations: the heat of combustion of the fossil fuel is not fully used by the boiler in the production of steam.

This clearly demonstrates how the gap in temperature between the entry level and the exit level of the smokestack is a key factor in traditional boilers. In a wide temperature gap the fire returns to the furnace choking it, in a narrow gap the combustion is not fully utilized and becomes a major source of pollution.

To counter the traditional thermodynamic evacuation of the exhausts from a boiler and avoid its limitation, the present invention introduces a totally new approach: the mechanical evacuation of the exhausts from the boiler where the temperature gap becomes irrelevant for here we can exceed the limitation of motility resulting from a wide temperature gap and thus extract more heat and make more steam.

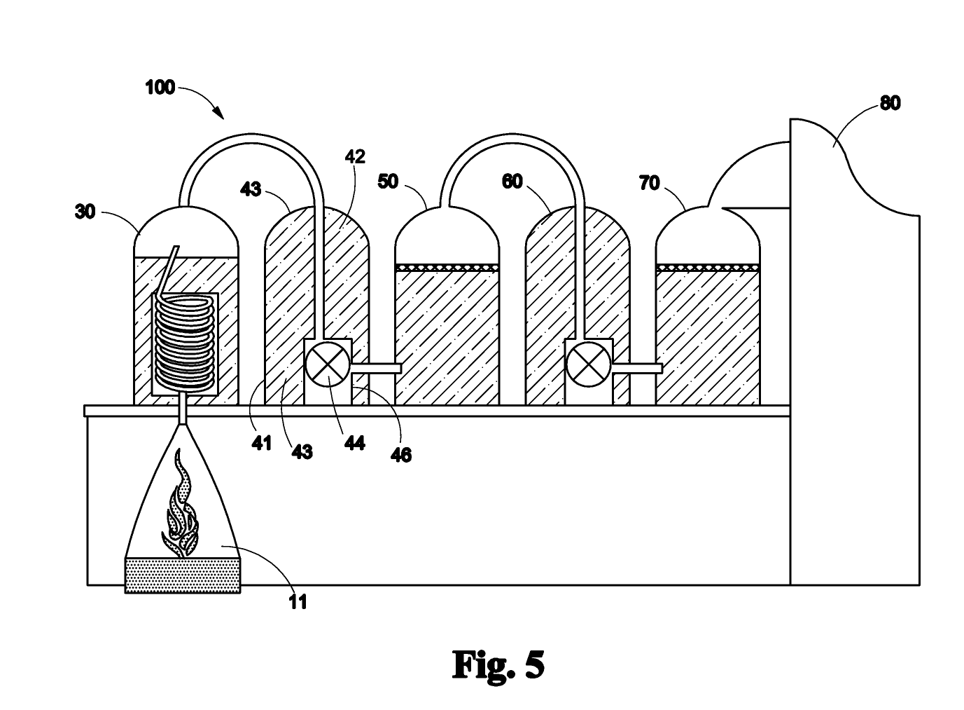

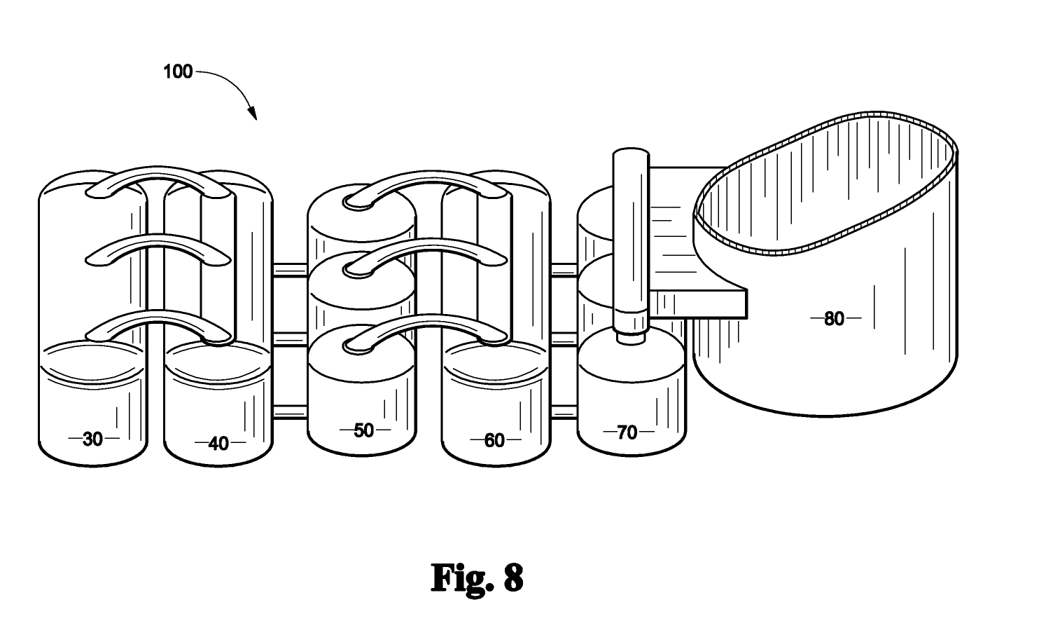

According to aspects of the present invention, a remedy presented herein is to utilize a multi-stage exhaust apparatus 100 to reduce the emission of pollutants from a fossil fuel furnace 11 and to achieve greater efficiency in the energy consumption by such furnace 11. As may be seen in reference to FIGS. 5-8, the multi-stage exhaust apparatus 100 may include a vacuum chamber boiler 30, a submerged pump station 40, a bath scrubber 50, and a clean air tower 80. Where additional cleaning and/or cooling capacity is required, the system may further include a secondary submerged vacuum station 60 and a secondary bath scrubber 70. The exhausts are communicated from the furnace 11 through the apparatus 100, and are released to the atmosphere via the clean air tower 80.

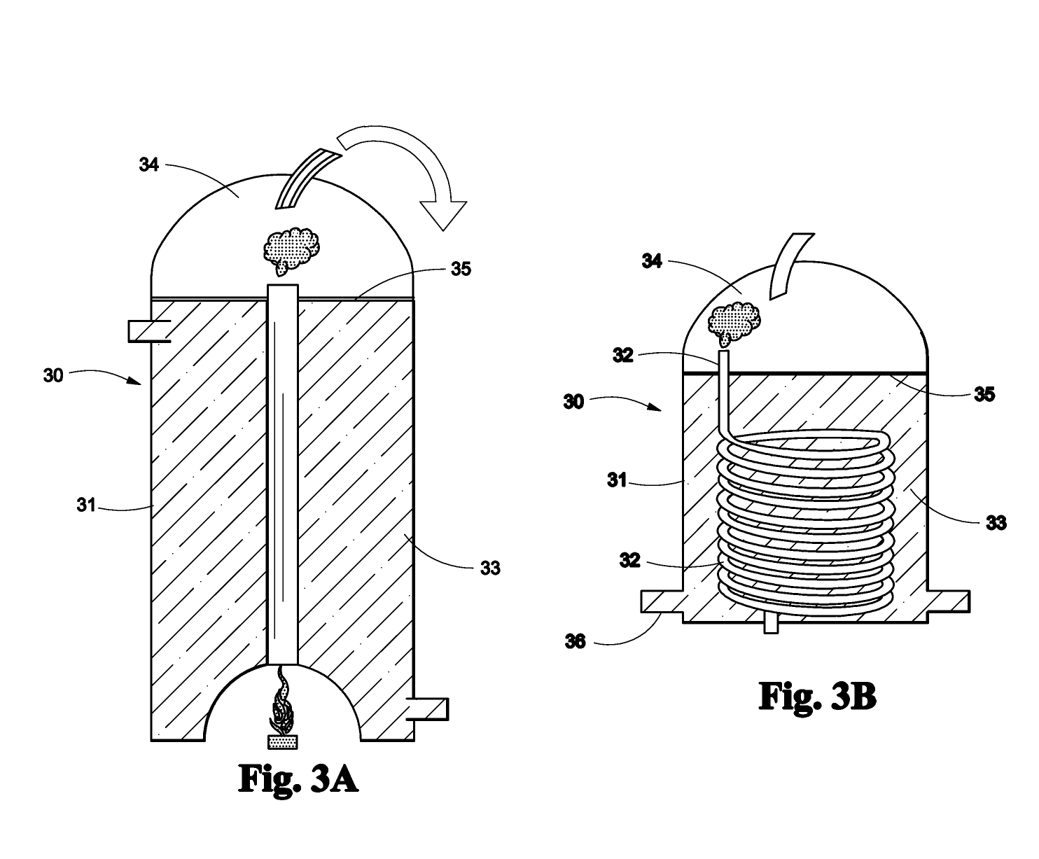

Initially, a vacuum chamber boiler 30, such as that depicted in reference to FIG. 3, is provided instead of the traditional pipe fire boiler 20 as seen in FIG. 2. As seen in reference to FIG. 3, a furnace 11, that is located for example on a ground level or subterranean level of a site sends the combustion gasses and entrained particulates, hereinafter exhausts or flue gasses, to a second, or higher elevation floor and into a vacuum chamber boiler 30.

The vacuum chamber boiler 30 includes a sidewall 31 defining a boiler chamber 33 and an upper vacuum chamber 34. A sealing plate 35 separates the boiler chamber 33 from the upper vacuum chamber 34. The boiler chamber 33 is operatively connected to a source of water that fills and is contained within the boiler chamber 33 and heated by the furnace 11 to produce steam. The steam is communicated via an outlet 36 to be utilized as an energy source, such as to power a turbine generator (not shown).

To improve the energy extraction from the fossil fuel burned in the furnace 11, the vacuum chamber boiler 30 is provided with an articulated or serpentine stack 32 that communicates the exhausts received from the furnace 11 through the boiler chamber 33, the sealing plate 35 and empties to the vacuum chamber 34. The length of the articulated stack 32 is selected to correspond to the length of a conventional tall stack 12 for a furnace 11 of like capacity. In case of waste burners where steam is not produced, the temperature may be circulated to a large body of water or other heat sink, to cool the exhausts of the waste burner.

A distinct advantage of the vacuum chamber boiler 30 of the present invention is that the articulated stack 32 allows for greater energy extraction from the combustion, by transferring energy the water contained within the boiler chamber 33. Concurrently, the exhaust gasses are cooled as they transit the articulated stack 32 and are received in the vacuum chamber 34.

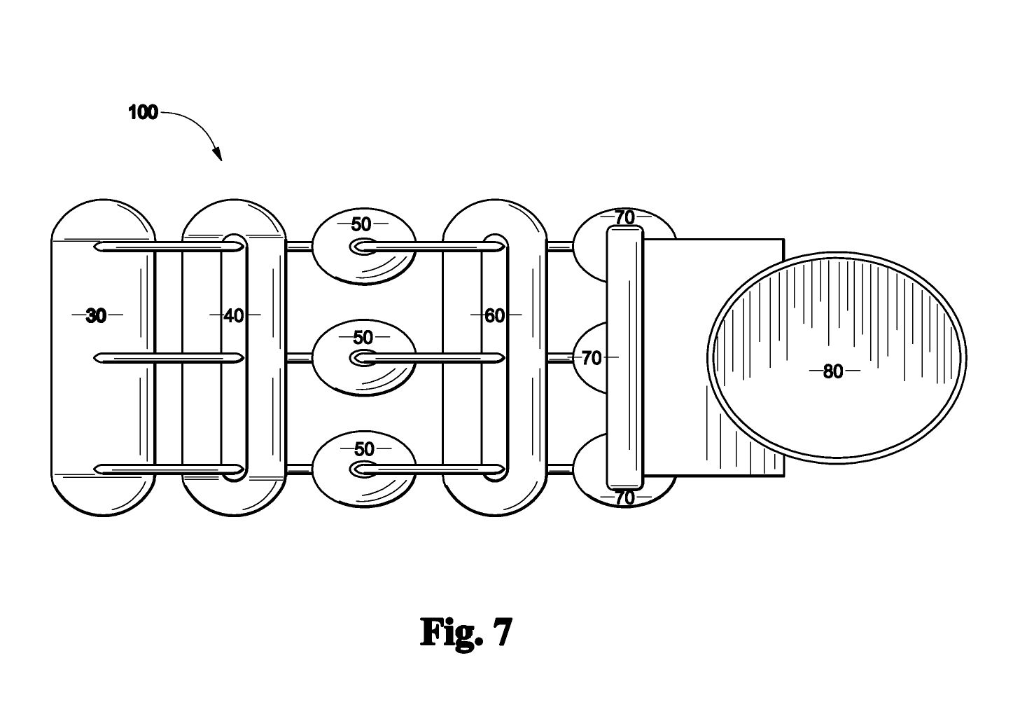

As seen in reference to FIG. 7, the vacuum chamber boiler 30 may be an elongate body and the articulated stack 34 may traverse lengthwise across the chamber as it winds upwardly within the boiler chamber 33.

In an alternative embodiment of the vacuum chamber boiler 30 of the present invention is shown in reference to FIG. 3A, wherein the length of a conventional straight smokestack 32 is bathed in water in the boiler chamber 33. A sealing plate 35 separates the boiler chamber 33 from the vacuum chamber 34.

In the vacuum chamber boiler 30, exhaust motility is not thermodynamically driven, rather it is forced mechanically by the deficit pressure of the vacuum chamber 34 and the suction provided via the vacuum station 40. Accordingly, the length of the smokestack can be selected to achieve substantial equilibrium between the temperature of the exhausts evacuated into the vacuum chamber 34 and the temperature of the steam producing liquid contained within the boiler chamber 33.

In a next stage, a submerged pump vacuum station 40, applies suction to the upper vacuum chamber 34 of the vacuum chamber boiler 30 and evacuates the exhausts from the vacuum chamber 23. The submerged pump vacuum station 40 includes an outer wall 41 defining a vacuum station cavity 43 therein and at least one high volume vacuum pump 44 that is coupled via a vacuum conduit 42 to the boiler's vacuum chamber 34. The vacuum conduit 42 communicates the exhausts from the vacuum chamber 35 through the vacuum station cavity 43 to the bath scrubber 50. Preferably, the vacuum conduit 42 is immersed in a cooling fluid, such as water, circulating through the vacuum stage cavity 43, to further cool the exhausts as they transit the vacuum station cavity 43.

In certain preferred embodiments of the invention, the vacuum pump 44, may be contained within a housing 45 located within vacuum station cavity 43 and submerged in the circulating cooling fluid. By submerging the vacuum pump 44 in the cooling fluid, the vacuum pump 44 carrying the hot exhausts is kept cool. This configuration leads to the derived name of the vacuum pump 44 as a submerged pump 44. The output of the submerged pump 44 communicates the exhausts to the bath scrubber 50 via a vacuum station outlet 46.

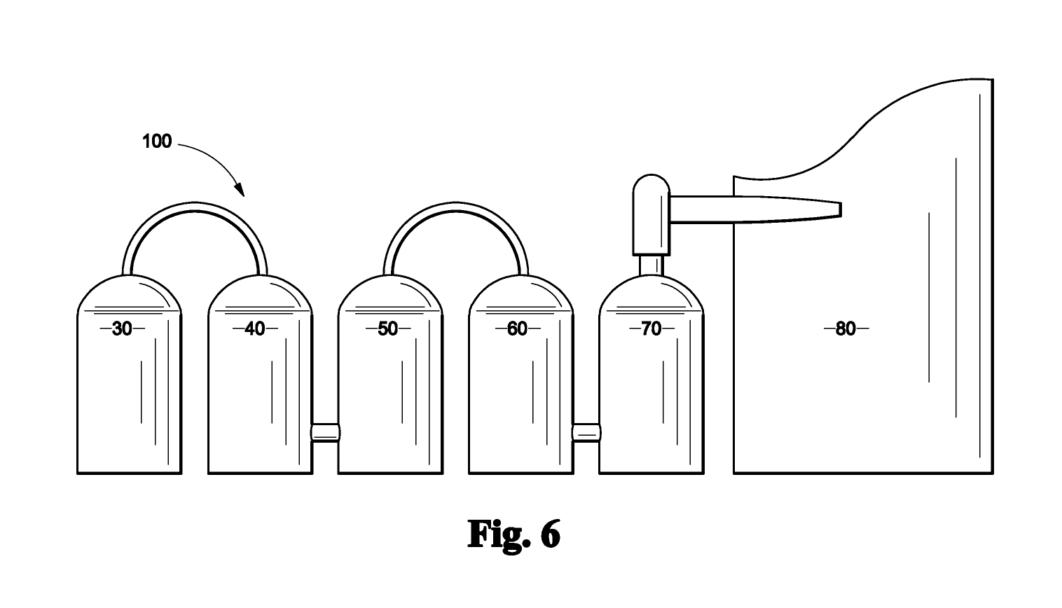

Referring again to FIGS. 6-8, the submerged pump vacuum station 40, is preferably equipped with a plurality of submerged pumps 44, each of which is operatively connected with the boiler's vacuum chamber 34 with an independent vacuum conduit 42 having a valve to selectively control the flow of exhausts through the respective vacuum conduit 42. Preferably, each vacuum conduit 42 and associated vacuum pump 44 is independently controlled from the others.

Present wet scrubbers shower lime water on hot exhausts ascending the smokestack and remove pollutants. Some flue gases however always escape, because hot exhausts ascend too quickly and do not spend enough time in contact with the showering lime water. These conventional wet scrubbers are inefficient. Whereas, as seen below the bath scrubber 50 of the present invention treats cold slow moving exhausts are percolated through a treatment bath 50.

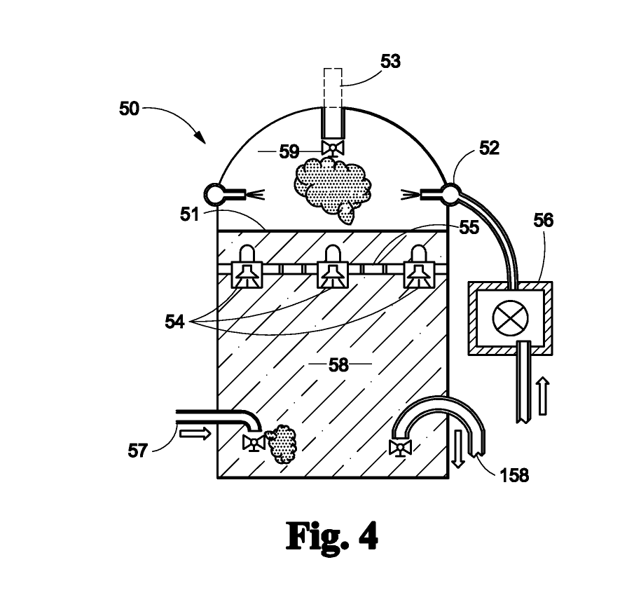

As seen in reference to FIG. 4, the bath scrubber 50, includes a main chamber 58 that is substantially filled with a volume of lime water bath to a fill level indicated by fill line 51. Exhausts are communicated into the bath via a bath inlet 57. The exhausts then percolate through the lime water solution to further cool the exhausts and precipitate out particulates that may be entrained in the exhausts.

The bath scrubber 50 may also include a screen or perforated plate 55 that spans a cross sectional area of the scrubber 13 below the fill line 51 of the main chamber 58. The perforated plate permits the exhausts to aerate as they rise upwardly into the spray chamber 59, defined above the fill line 51 of the bath scrubber 50. The perforated plate 55 also permits accumulated lime spray to circulate back to the lower portion of the main chamber 58.

A plurality of high frequency sound wave emitters 54 may also be provided in an array on, or proximal to, the perforated plate 55. Ultrasonic waves emitted into the bath perform two functions. First, the ultrasonic waves will facilitate the mixing by fomenting the bath 58 and exhausts, as in ultrasonic aeration, and allow for a better surface area contact, contact time and mixing of the exhausts with the lime water bath before exiting the bath 58 to then encounter the lime spray emitted by sprayers 52. Second, the emitters 54 send ultrasonic pulses through the lime bath which also facilitates the agglomeration of particulates that have become suspended or trapped in the lime bath 58.

The agglomeration of the particulates facilitates their settlement to the bottom of the bath scrubber 50 and their subsequent removal from the bath. A dirty lime outlet 158, controlled with a valve, permits the replenishment and removal of the particulate laden lime water that accumulates at the bottom of the scrubber 50.

In addition to the lime water bath, the bath scrubber 50 also includes a sprayer 52, similar to conventional scrubbers. A source of lime water is pumped into an upper portion 59 of the main chamber via a pump 56, where it is conveyed to at least one spray nozzle 52 that sprays lime water into the upper portion of the main chamber 59. The sprayed lime further reacts with the exhausts to chemically bond with pollutants or otherwise physically precipitate out particulates that may be entrained in the exhausts.

An exit port 53 is provided at a top of the bath scrubber 50 to permit the evacuation of the cleaned exhausts from the scrubber 50. Depending on the particulate levels and temperature remaining in the exhausts, the exit port 53 may be connected to a clean air tower 80 for release into the atmosphere. In certain embodiments of the apparatus, a second stage of cooling is provided by a secondary submerged vacuum station 60. Operation of the secondary submerged vacuum station 60 is substantially the same as that previously described for the first submerged pump vacuum station 40. In additional preferred embodiments, a secondary bath scrubber 70, may also be provided in which the configuration and operation are substantially the same as that described for the first bath scrubber 50.

In certain preferred embodiments, the secondary bath 70 may be different than the first because some pollutants do not respond well to lime water agglomeration and need bathing in different chemical components. In this instance the bath may include ammonia, or other chemicals suitable to the pollutants contained within the source of coal. Due to the nature of the bath, the treated pollutants rise out of the bath. In certain embodiments, the particulates and pollutants may be intercepted by an electrostatic precipitator whose components are a highly negative charged screen 72 fed by line 74 and a high positively charged ring 73. These opposing electrical fields precipitate any remaining pollutants.

In a final stage the clean cooled exhausts is transferred by 46 to the releasing clean air tower 80. As with conventional stacks, the tower has a heating electrical ring that creates a draft to lift the air up into the atmosphere. Due to the low temperature of the exhausts, the amount of heat that needs to be applied to ensure flow of the air through the stack is substantially reduced.

As will be appreciated, the improved efficiency of the lime water bath 50 will increase the rate at which carbon and other particulates, that are accumulated, presenting an added challenge for disposal of these waste products.

The particulate laden lime water wastes may be collected and desiccate the used lime water. The desiccated wastes may be poured in a box or cylindrical form structures. Silica sand is added to the wastes and the composition is heated to melt and form an outer glass covering for the wastes contained within vitrified blocks 91. A metal anchor 92 should be provided inside the vitrified blocks 91 for subsequent handling. Once a sufficient number of vitrified blocks 91 are accumulated, the vitrified blocks 91 may be deposited via a ship's cable to lower them to a sandy and shallow sea floor, such as the Newfoundland bank east of Boston.

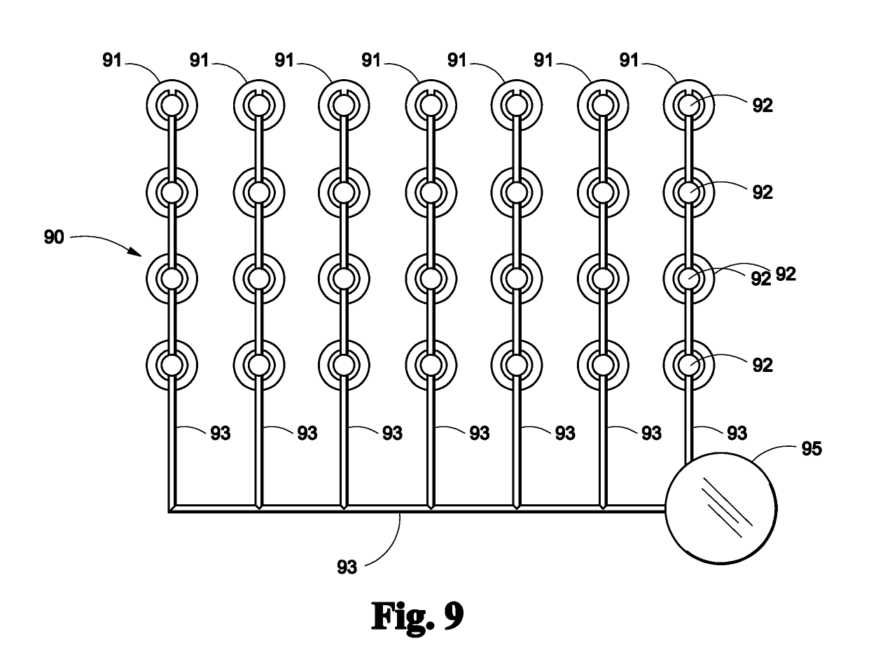

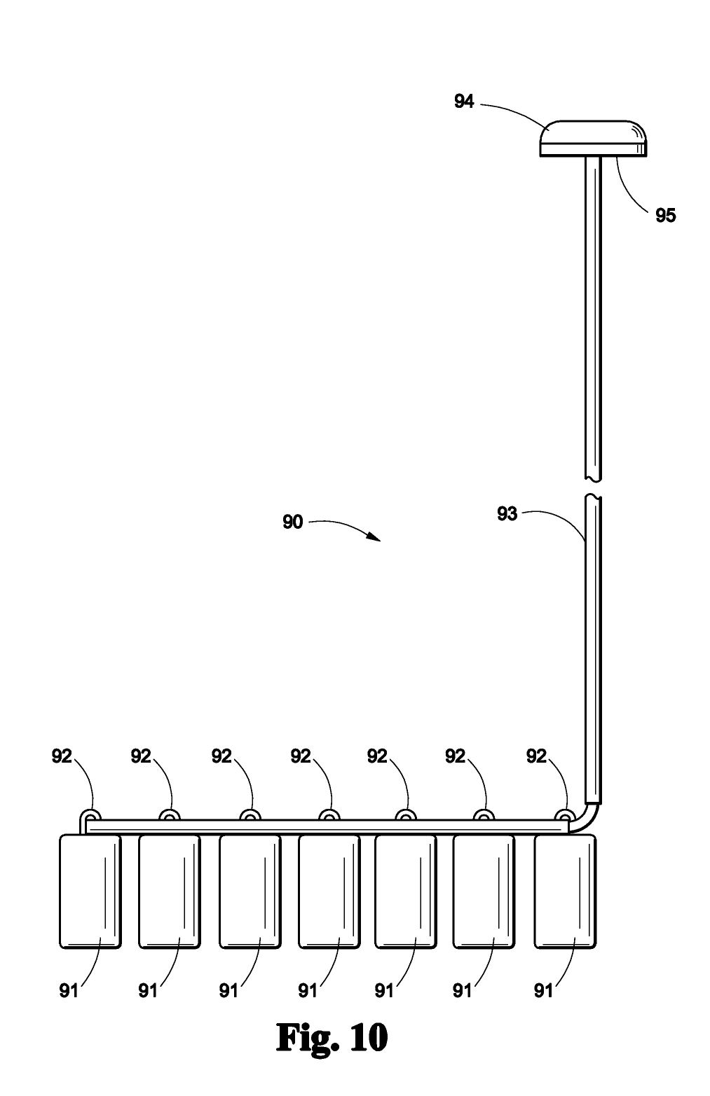

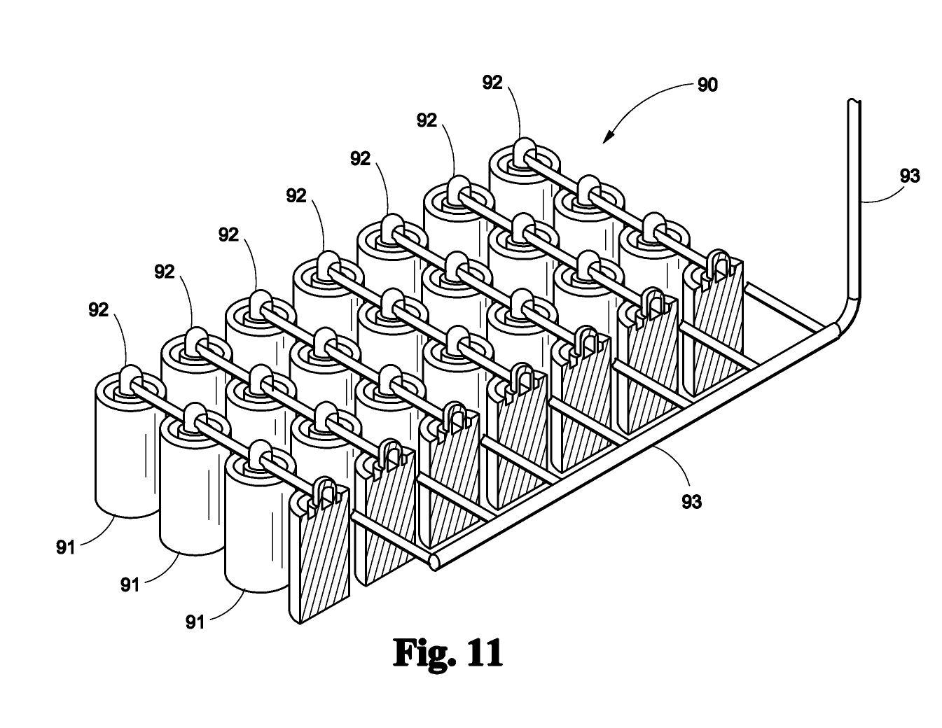

When the sea floor is well filled out with a field 90 of vitrified blocks 91, as seen in reference to FIGS. 9-11, a small electric current provided by a solar panel 94 attached to a floating buoy 95 is communicated to anchors 92 via a conductive cable 93.

Because this shallow sea floor receives sunlight to facilitate algae and other sea vegetation that need carbon dioxide, sunlight and water to grow. The field 90 may also be seeded with baby marine barnacles. The absorption of carbon dioxide by the marine plants will decrease acidity in water around the field 90 and thus facilitating the seeded nursery bowl content next to the ion post to start forming a reef by absorbing carbonates from the deposited waste containing cylinders 91.

It should be understood, of course, that the foregoing relates to exemplary embodiments of the invention and that modifications may be made without departing from the spirit and scope of the invention as set forth in the following claims.

What is claimed is:

1. A vacuum chamber boiler comprising:
an elongate body having a sidewall defining a cavity therein,
a sealing plate extending across said cavity and sealingly engaging with an interior surface of said sidewall to define a boiler chamber in a lower portion of said cavity and a vacuum chamber in an upper portion of said cavity; and
a smokestack substantially contained within said boiler chamber and extending from a first opening at bottom of said boiler chamber to a second opening in said sealing plate, said smokestack adapted to communicate exhausts received from a furnace through said first opening and said second opening, said second opening in communication with said vacuum chamber;
wherein said boiler is adapted to receive a source of liquid for producing steam, and the vacuum chamber is adapted to receive a vacuum source applied to an outlet of said vacuum chamber.

2. The vacuum chamber boiler of claim 1, wherein said smoke stack is articulated within said boiler chamber.

3. The vacuum chamber boiler of claim 2, wherein said smoke stack is articulated along a width, a length and a height of said boiler chamber.

4. The vacuum chamber boiler of claim 1, wherein the length of the smoke stack within the boiler chamber is selected such as to approach equilibrium of the exhausts temperature at said sealing plate opening with the temperature of the source of liquid producing for producing steam.

5. The vacuum chamber boiler of claim 1, wherein said vacuum source comprises a vacuum pump, connected to said vacuum chamber outlet via a conduit, wherein said vacuum pump is submerged in a circulating source of cooling fluid contained within a vacuum station external to said vacuum chamber boiler.

6. The vacuum chamber boiler of claim 5, wherein said vacuum source comprises a plurality of vacuum pumps submerged in said vacuum station, each said vacuum pump connected to said vacuum chamber via a separate conduit.

7. A bath scrubber comprising:
a main chamber defined by an outer wall of said bath scrubber;
said main chamber having a lower portion adapted to contain a volume of a of chemical water bath to a fill line of said main chamber and an upper portion defined above said fill line;
an inlet defined in said lower portion adapted to receive exhausts from fossil fuel combustion contained in a furnace;
a perforated plate extending across the lateral and longitudinal aspects of said main chamber beneath said fill line; and
an outlet defined in said upper portion adapted to evacuate said exhausts from said bath scrubber.

8. The bath scrubber of claim 7, further comprising:
a plurality spray nozzles projecting into said upper portion of said main chamber.

9. The bath scrubber of claim 7, further comprising:
a plurality of ultrasonic emitters positioned proximal said perforated plate, said emitters arrayed to foment said exhausts within said chemical water bath.

10. The bath scrubber of claim 7, further comprising:
a pump providing a pressurized source of chemical water to said spray nozzles.

11. The bath scrubber of claim 7, further comprising:
a vacuum source connected to said outlet.

12. The bath scrubber of claim 11, wherein said vacuum source comprises:
a vacuum pump, connected to said outlet via a conduit, wherein said vacuum pump is submerged in a circulating source of cooling fluid contained within a vacuum station external to said bath scrubber.

13. The bath scrubber of claim 12 wherein said vacuum source comprises a plurality of said vacuum pumps submerged in said vacuum station, each said vacuum pump connected to said vacuum chamber via a separate conduit.

14. An apparatus for cleaning flue gas, comprising:
a vacuum chamber boiler comprising:
an elongate body having a sidewall defining a cavity therein,
a sealing plate extending across said cavity and sealingly engaging with an interior surface of said sidewall to define a boiler chamber in a lower portion of said cavity and a vacuum chamber in an upper portion of said cavity; and
a smokestack substantially contained within said boiler chamber and extending from a first opening at bottom of said boiler chamber to a second opening in said sealing plate, said smokestack adapted to communicate exhausts received from a furnace through said first opening and said second opening, said second opening in communication with said vacuum chamber;
wherein said boiler is adapted to receive a source of liquid for producing steam, and the vacuum chamber is adapted to receive a vacuum source applied to an outlet of said vacuum chamber;
a bath scrubber comprising:
a main chamber defined by an outer wall of said bath scrubber, said main chamber having a lower portion adapted to contain a volume of a of chemical water bath to a fill line of said main chamber and an upper portion defined above said fill line;
an inlet defined in said lower portion adapted to receive exhausts from fossil fuel combustion contained in a furnace;
a perforated plate extending across the lateral and longitudinal aspects of said main chamber beneath said fill line; and
a vacuum outlet defined in said upper portion and connected to a vacuum source;
wherein said vacuum source comprises a vacuum pump, connected to said vacuum chamber outlet via a conduit, wherein said vacuum pump is submerged in a circulating source of cooling fluid contained within a vacuum station external to said vacuum chamber boiler.

15. The vacuum chamber boiler of claim 14, wherein said smoke stack is articulated along a width, a length and a height of said boiler chamber.

16. The apparatus for cleaning flue gas of claim 15, wherein the length of the smoke stack within the boiler chamber is selected such as to approach equilibrium of the exhausts temperature at said sealing plate opening with the temperature of the source of liquid producing for producing steam.
